(19) United States
(12) Patent Application Publication
(10) Pub. No.: US 2008/0230635 A1
(43) Pub. Date: Sep. 25, 2008

(54) Fluid Injector

(76) Inventors: Gianbattista Fischetti, Pisa (IT); Cristiano Zanoboni, Rosignano Solvay (LI) (IT)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 10/598,349

(22) PCT Filed: Jan. 18, 2005
(86) PCT No.: PCT/EP05/50186

§ 371 Date: Aug. 7, 2007

(30) Foreign Application Priority Data
Feb. 27, 2004 (EP) 04004593.2

(51) Int. Cl. F02M 51/00

(52) U.S. Cl. 239/585.5

(57) ABSTRACT

A fluid injector has a housing, a valve body and an actuator unit, that is inserted into the housing. The valve body has a cartridge with a recess, that takes in a needle (22). A receptance (221) is formed in the needle (22) and fixes a locking element (233) in an axial direction relative to the needle (22). A return spring (24) rests on the spring rest body (23) which is pretensioned in a way that it presses the spring rest body (23) against the locking element (233).

### CROSS-REFERENCE TO RELATED APPLICATIONS

This application is a U.S. national stage application of International Application No. PCT/EP2005/050186 filed Jan. 18, 2005, which designates the United States of America, and claims priority to European application number EP04004593.2 filed Feb. 27, 2004, the contents of which are hereby incorporated by reference in their entirety.

### TECHNICAL FIELD

The invention relates to a fluid injector. Known fluid injectors comprise a housing, a valve body and an actuator unit, which is inserted into the housing. The valve body comprises a cartridge with a recess, that takes in a needle. A pretensioned spring rests on a body, that is fixed to the needle. The pretensioned return spring rests, on the other hand, on a spring rest which is formed in the valve body. In addition to that the actuator unit acts on the needle.

### BACKGROUND

Depending on the force balance of the actuator unit and the return spring the needle opens or closes a nozzle and in that way controls the injection of fuel. In an increasing number of applications actuator units with a piezoelectric actuator are used. They have the advantage of having a very fast response time to actuating signals and like that enable multiple injections into a cylinder of the internal combustion engine during one working cycle of the cylinder.

WO 03/016707 A1 discloses a fluid injector with a connector to a fuel supply, a housing, an actuator unit, and a valve body. The housing is double tubed and has a recess, which takes in the actuator unit. The actuator unit comprises a piezoelectric actuator, which acts on the needle. Between the walls of the double tube-shaped housing the fuel is led from the connector to a fuel inlet of the valve body. The valve body has a housing part with a recess, that takes in a needle. Depending on the position of the needle a nozzle is opened or closed and respectively fuel is injected or not.

### SUMMARY

The object of the invention is to create a fluid injector, which is simple to manufacture.

The invention is distinguished by a fluid injector with a housing, a valve body, and an actuator unit, that is inserted into the housing. The valve body comprises a cartridge with a recess, that takes in a needle. A receptance is formed in the needle and fixes a locking element in axial direction relative to the needle. A spring rest body has a recess, through which the needle protrudes and which takes in the locking element and fixes it in the radial direction relative to the needle. A return spring rests on the spring rest body and is pretensioned in a way, that it presses the spring rest body against the locking element.

The fluid injector has the advantage, that the spring rest body and the locking element are easy to manufacture. The locking element may be formed by a simple blanking operation for example. The locking element, the spring rest body and the needle may be assembled by simply putting the parts together without having to stress the material, which is for example the case when a crimping operation is necessary.

In addition to that there is also no need to weld or to solder the parts together. This is especially advantageous for the needle whose material can then be chosen to be the best suited for opening and closing the nozzle during a long period of operation without changing the characteristic of the fluid injection.

In an advantageous embodiment of the invention the locking element is conically-shaped on the surface facing the spring rest body and the receptance of the spring rest body is correspondingly conically-shaped. This ensures the alignment of the spring rest body in a simple way even if there are manufacturing tolerances for the locking element and the spring rest body.

### BRIEF DESCRIPTION OF THE DRAWINGS

Exemplary embodiments of the invention are explained in the following with the aid of schematic drawings. These are as follows:

FIG. 1 a fluid injector,

FIG. 2 a part of the needle of the fluid injector according to FIG. 1,

FIG. 3 the part of the needle in another embodiment of the fluid injector, and

FIG. 4 a locking element.

Elements of the same design and function that occur in different illustrations are identified by the same reference character.

### DETAILED DESCRIPTION

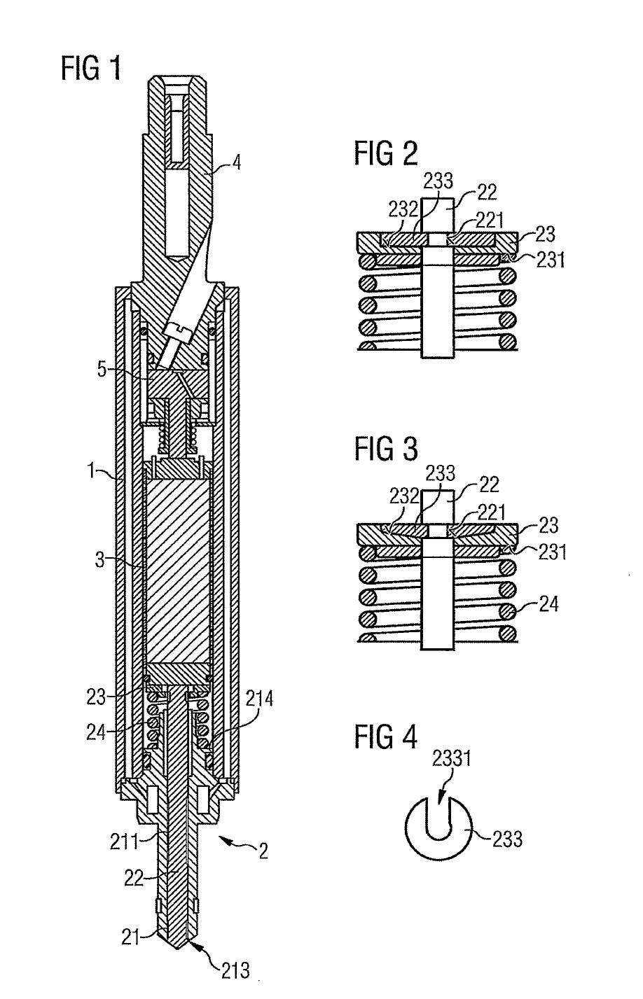

A fluid injector (FIG. 1) that is used as a fuel injector for an internal combustion engine, comprises a housing 1, a valve body 2, an actuator unit 3, a fuel connector 4 and a thermal compensator 5. The fuel connector 4 is designed to be connected to a high pressure fuel chamber of an internal combustion engine, where fuel is stored under high pressure, for example under the pressure of about 200 Bar.

The housing 1 has a tubular shape. The fuel connector 4 is fixed to the housing 1 on one of its free ends. The thermal compensator 5 is inserted into the housing 1 and contacts the actuator unit 3. The actuator unit 3 comprises in a preferred embodiment a piezo actuator, which changes its axial length depending on a control signal applied to it. The actuator unit 3 may, however, also comprise another type of actuator unit, which is known to a person skilled in the art for that purpose. Such an actuator unit may be, for example, a solenoid.

The fluid injector further comprises the valve body 2. The valve body 2 comprises a cartridge 21 with a recess 211 which is axially lead through the cartridge 21. A needle 22 is taken in the recess 211 of the cartridge 21. On one of the free ends of the recess 211 an injection nozzle 213 is formed, which is closed or opened depending on the axial position of the needle 22.

A spring rest body 23 is coupled to the needle 22 and stays in a fixed position relative to the needle independent of the movement of the needle 22. The spring rest body 23 forms a first spring rest 231 for a return spring 24. A second spring rest 214 is formed preferably in the cartridge 21. The spring rest body 23 and the cartridge 21 are assembled in a way, that a given characteristic of the fluid injector is ensured. This characteristic may be achieved during the manufacturing process by moving the cartridge until the given characteristic is achieved and then finally fixing it to the housing 1. For that purpose it is preferred that the cartridge 21 is formed out of two parts with one part forming the injection nozzle 213 and the other part comprising the second spring rest 214. The first and second parts of the cartridge then need to be moveable relative to each other during the manufacturing process before they are permanently fixed to each other.

The needle 22 comprises a receptance 221, which is preferably shaped in the form of a groove that is preferably formed as a decrease in diameter of the needle 22 for a given axial length. A locking element 233 is fixed in the receptance 221 and is fixed in that way in the axial direction relative to the needle 22.

The spring rest body 23 comprises a recess 232 through which the needle 22 protrudes and which takes in the locking element 233 and fixes it in the radial direction relative to the needle 22.

The return spring 24, which rests on the first spring rest 231 pushes the spring rest body 23 in axial direction relative to the needle 22 towards the locking element 233 and fixes in that way the locking element 233 in the recess 232 of the spring rest body 23.

The assembly process is preferably as follows. The needle 22 is inserted into the recess 211 of the cartridge 21. After that the return spring 24 is brought into contact with the second spring rest 214, which is formed in the cartridge 21. After that the spring rest body 23 is moved onto the needle until it is in a position which is closer towards the second spring rest 214 than the receptance 221 of the needle 22. It is then kept in that position and the locking element 233 is inserted into the receptance 221 of the needle 22 from a preferably radial direction relative to the needle 22. The spring rest body 23 is after that allowed to move back till it contacts the locking element 233 in the area of its recess 233 and in that way takes in the locking element 233 in the recess 232 of the spring rest body 23. After that the valve body is inserted into the housing 1 of the fluid injector and the pretension of the return spring 24 is adjusted as explained above.

In another embodiment of the fluid injector (FIG. 3) the locking element 233 is conically-shaped on the side facing towards the recess 232 of the spring rest body 23. The recess 232 of the spring rest body 23 has a corresponding shape. In that way it can easily be ensured that the spring rest body 23 is properly aligned to the needle 22.

The fuel is lead from the fuel connector 4 through the space between the double-tubed walls of the housing 1 towards the cartridge and then towards the injection nozzle 213. Alternatively the housing may also comprise only one tube and fuel is then lead around the actuator unit 3 towards the injection nozzle.

The axial position of the needle 22, which determines whether the injection nozzle 213 is opened or closed, depends on a force balance between the return spring 24 and the forces applied to the needle 22 by the actuator unit 3.

In the explained embodiments the fluid injector is designed to be normally closed, that means if no control signal is applied to the actuator unit 3, the needle 22 is pushed in its seat by the spring force of the return spring 24 and by that closes the injection nozzle 213. If a respective control signal is applied to the actuator unit 3 the actuator unit changes its axial length and in that way controls whether the injection nozzle 213 is opened or closed by the needle 22. The fluid injector may however also be designed to be normally open or may be of an inward opening type.

What is claimed is:

1. A fluid injector comprising a housing, a valve body and an actuator unit inserted into the housing, wherein the valve body comprises a cartridge with a recess that takes in a needle, a receptance, which is formed in the needle and fixes a locking element in axial direction relative to the needle, and a spring rest body, which has a recess, through which the needle protrudes and which takes in the locking element and fixes it in the radial direction relative to the needle, and a return spring which rests on the spring rest body which is pretensioned in a way that it presses the spring rest body against the locking element.

2. A fluid injector in accordance with claim 1, wherein the locking element is conically-shaped on the surface facing the spring rest body and the recess of the spring rest body is correspondingly conically-shaped.

3. A fluid injector according to claim 1, wherein the housing comprises a double-tubed wall.

4. A fluid injector according to claim 3, further comprising a fuel connector, wherein fuel is lead through the double-tubed wall towards the injection nozzle.

5. A fluid injector according to claim 1, comprising a fuel connector, wherein fuel is lead around the actuator unit the injection nozzle.

6. A fluid injector according to claim 1, wherein the fluid injector is turned into an open mode when actuated.

7. A fluid injector according to claim 1, wherein the fluid injector is turned into a closed mode when actuated.

8. A method for assembling a fluid injector comprising the steps of:
inserting a needle into a recess of a cartridge of a valve body;
thereafter, bringing a return spring into contact with a second spring rest, which is formed in the cartridge;
thereafter, moving a spring rest body onto the needle until it is in a position which is closer towards the second spring rest than a receptance of the needle;
inserting a locking element into the receptance of the needle;
allowing the spring rest body to move back till it contacts the locking element in the area of its recess and in that way takes in the locking element in the recess of the spring rest body.

9. A method according to claim 3, further comprising the step of inserting the valve body into a housing of the fluid injector.

10. A method according to claim 4, further comprising the step of adjusting a pretension of the return spring.

11. A method according to claim 3, wherein the step of inserting the locking element into the receptance of the needle is performed from a radial direction relative to the needle.

12. A fluid injector comprising a housing, a valve body and an actuator unit inserted into the housing, wherein the valve body comprises a cartridge with a recess that takes in a needle, a receptance, which is formed in the needle and fixes a locking element in axial direction relative to the needle, and a spring rest body, which has a recess, through which the needle protrudes and which takes in the locking element and fixes it in the radial direction relative to the needle, and a return spring which rests on the spring rest body which is pretensioned in a way that it presses the spring rest body against the locking element, wherein the locking element is conically-shaped on the surface facing the spring rest body and the recess of the spring rest body is correspondingly conically-shaped.

13. A fluid injector according to claim 12, wherein the housing comprises a double-tubed wall.

14. A fluid injector according to claim 13, further comprising a fuel connector, wherein fuel is lead through the double-tubed wall towards the injection nozzle.

15. A fluid injector according to claim 12, comprising a fuel connector, wherein fuel is lead around the actuator unit the injection nozzle.

16. A fluid injector according to claim 12, wherein the fluid injector is turned into an open mode when actuated.

17. A fluid injector according to claim 12, wherein the fluid injector is turned into a closed mode when actuated.
